(19) United States
(12) Patent Application Publication
(10) Pub. No.: US 2006/0058456 A1
(43) Pub. Date: Mar. 16, 2006

(54) Multiple-component variable hardness polyurethane system

(75) Inventor: Dipak Parekh, Waterloo (CA)

Correspondence Address: DIMOCK STRATTON LLP, 20 QUEEN STREET WEST SUITE 3202, BOX 102, TORONTO, ON, M5H 3R3, CA

(73) Assignee: Crosslink Technology Inc., Toronto (CA)

(21) Appl. No.: 11/216,134

(22) Filed: Sep. 1, 2005

(30) Foreign Application Priority Data
Sep. 2, 2004 (CA) 2,480,364

(51) Int. Cl. C08G 18/08

(52) U.S. Cl. 524/589

(57) ABSTRACT

A multi-component variable hardness polyurethane system and method of creating a thermosetting composition having a particular hrdness. In the preferred embodiment a polyurethane compund can be created having any desired hardness between 10 and 90 Shore A, by mixing the same two curative components in different proportions, according to the hardness desired, along with a stoichiometrically determined amount of isocyanate as a hardener.

### FIELD OF THE INVENTION

This invention relates to thermosetting compounds. In particular, this invention relates to a multiple-component thermosetting composition that uses the same basic components but the hardness of which can be varied over a wide range according to the proportion of the components used.

### BACKGROUND OF THE INVENTION

Thermosetting compounds are used in a variety of applications. One popular thermosetting compound, polyurethane, is used for example on rollers for printers, photocopiers and the like, in which a polyurethane coating is applied over a steel mandrell. Polyurethane is also popularly used to fabricate components for manufacturing machinery, and in myriad other applications.

In many cases, manufacturers require thermosetting compounds having a wide range of different hardnesses. This requires that many of different compounds be maintained in inventory, which can be an organizational problem and can be quite confusing to workers who have to locate the compound of the desired hardness for a particular application. The application of thermosetting compounds of different hardnesses also often requires that manufacturing equipment be changed or adjusted to accommodate the different properties of a thermosetting compound having a different hardness.

It would accordingly be advantageous to provide a system and method which can create a thermosetting composition of a desired hardness within a wide range of hardnesses using a small number of components.

### SUMMARY OF THE INVENTION

The present invention provides a multi-component variable hardness polyurethane system. According to the invention a thermosetting composition, in particular polyurethane, can be created having any desired hardness between 10 and 90 Shore A, by mixing the same curative components in different proportions, according to the hardness desired, along with a stoichiometrically determined amount of isocyanate as a hardener.

In the preferred embodiment the composition of the invention can be created from three components: two curative components and an isocyanate. However, additional components may be used to create a composition within the scope of the invention.

### BRIEF DESCRIPTION OF THE DRAWINGS

In drawings which illustrate by way of example only a preferred embodiment of the invention,

FIG. 1 is a graph showing percentages of components for the production of a polyurethane of a defined hardness.

FIG. 2 is a chart showing mix ratios for the components in the preferred embodiment of the invention to create a composition having a hardness in a range from 10 Shore A to 90 Shore A.

### DETAILED DESCRIPTION OF THE INVENTION

In the preferred embodiment, the invention comprises a polyurethane compound having specific percentages of first and second curative components, and an isocyanate or hardening agent, for example methylene diphenyl isocyanate, added in a stoichiometrically determined amount. The preferred components are described herein by way of example for the preferred embodiment, however the invention is not intended to be limited to the specific components so described.

The first curative component is selected to have a very low hardness when mixed alone with the isocyanate, for example a composition containing glycol polyol, non reactive plasticizer, urethane catalyst, and a surfactant, in suitable proportions. The second curative component is selected to have a very high hardness when mixed alone with the isocyanate, for example a composition containing glycol polyol, liquid aromatic diamine, urethane catalyst, and a surfactant, in suitable proportions. The first and second components must be miscible, although, not necessarily upon first mixing.

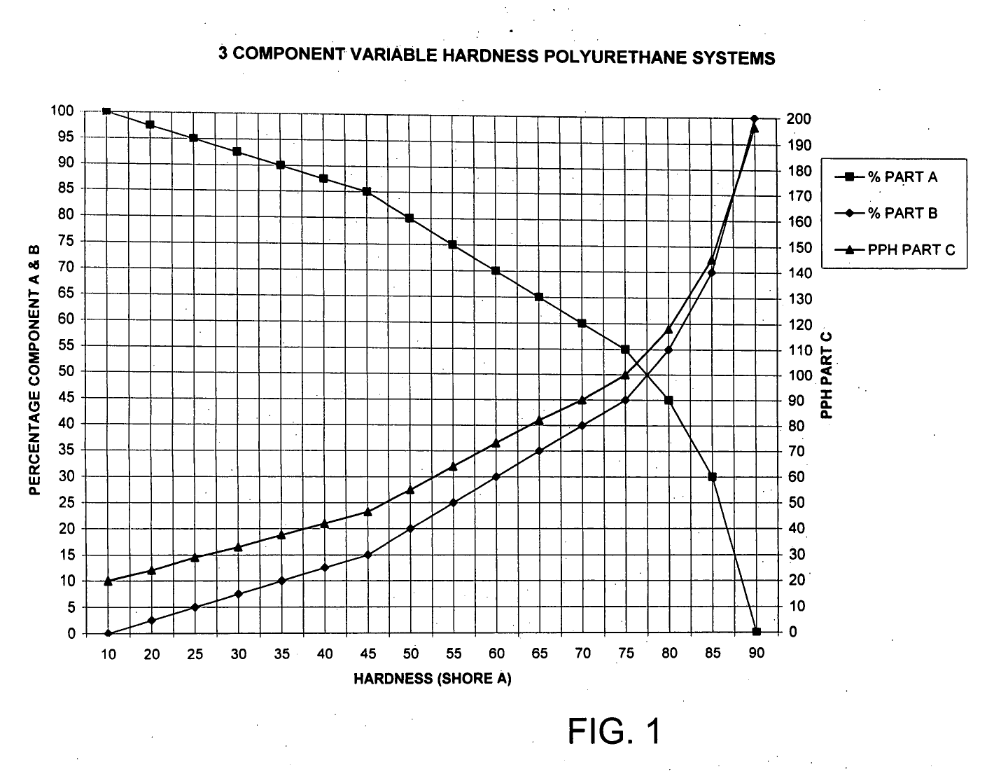

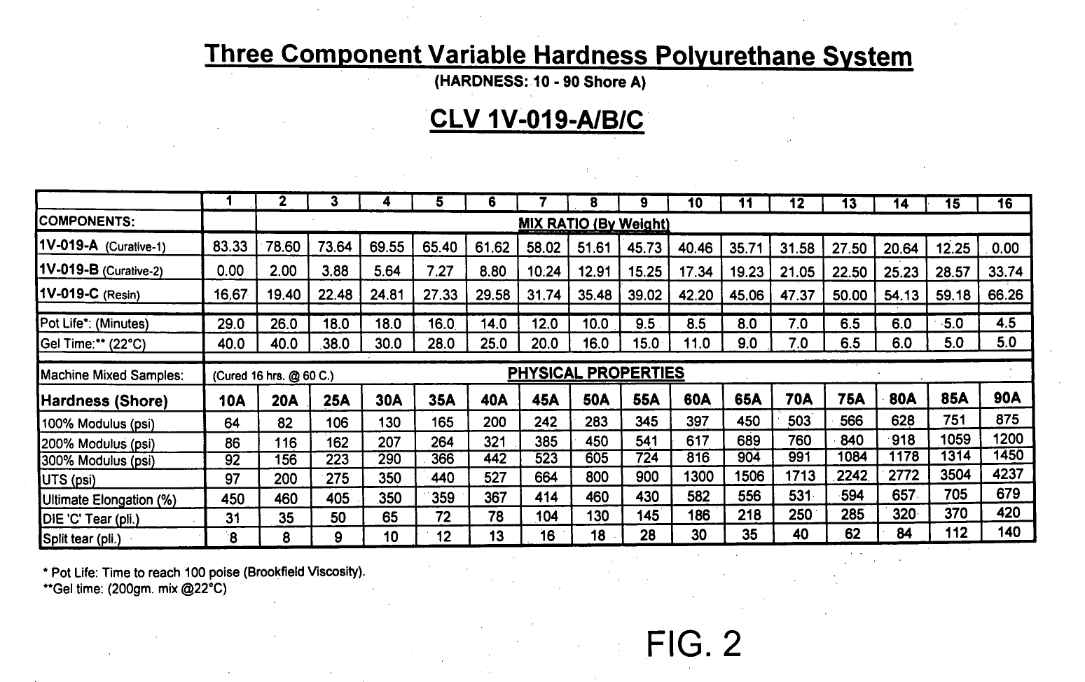

As can be seen from FIGS. 1 and 2, the relative percentages of the two curative components are selected to create a polyurethane compound having a desired hardness. The amount of isocyanate added as a hardener is determined stoichiometrically, based on the molecular weights and proportions of the curative components. A harder polyurethane requires a tighter crosslink chemistry, and therefore smaller molecules, so as the hardness of the polyurethane compound increases more isocyanate is required in the composition to maintain the stoichiometric relation between the hardener and the curative components. The percentage of each curative component can be selected from a chart generated by experimentation, for example as illustrated in FIG. 2 in the case of the specific components used in the preferred embodiment of the invention.

Moreover, in the system and method of the invention the relationship between the proportions of the two curative components and the hardness of the resulting composition is relatively linear, so interpolation between incremental mixture ratios will achieve roughly the desired intermediate hardness. For example, to create a polyurethane compound having a hardness of 67.5 Shore A, and intermediate amount of curative components and isocyanate between the percentages shown in columns 11 and 12 of FIG. 2 would be mixed to yield a compound having a hardness very close to the desired result. With some experimentation a precise hardness can be achieved.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A thermosetting composition, comprising
a hardener,
a first curative component having a low hardness when mixed alone with the hardener,
a second curative component having a high hardness when mixed alone with the hardener,
the first and second components being miscible, and when mixed together in a different proportions creating with the hardener thermosetting compositions having different hardnesses within a range of hardnesses between the low hardness and the high hardness.

2. The composition of claim 1 in which the composition is a polyurethane.

3. The composition of claim 2 in which the hardener is an isocyanate.

4. The composition of claim 3 in which the hardener is methylene diphenyl isocyanate.

5. The composition of claim 4 in which the range of hardnesses is between 10 Shore A and 90 Shore A.

6. The composition of claim 5 in which the first curative component comprises a composition containing glycol polyol, non reactive plasticizer, urethane catalyst, and a surfactant.

7. The composition of claim 6 in which the second curative component comprises a composition containing glycol polyol, liquid aromatic diamine, urethane catalyst, and a surfactant.

8. A variable hardness polyurethane system, comprising
a hardener,
a first curative component having a low hardness when mixed alone with the hardener,
a second curative component having a high hardness when mixed alone with the hardener,
the first and second components being miscible, and when mixed together in a different proportions creating with the hardener polyurethane compounds having different hardnesses within a range of hardnesses between the low hardness and the high hardness.

9. The polyurethane system of claim 7 in which the hardener is an isocyanate.

10. The polyurethane of claim 9 in which the hardener is methylene diphenyl isocyanate.

11. The polyurethane system of claim 9 in which the range of hardnesses is between 10 Shore A and 90 Shore A.

12. The polyurethane system of claim 11 in which the first curative component comprises a composition containing glycol polyol, non reactive plasticizer, urethane catalyst, and a surfactant.

13. The polyurethane system of claim 12 in which the second curative component comprises a composition containing glycol polyol, liquid aromatic diamine, urethane catalyst, and a surfactant.

14. A method of creating polyurethane compounds having different hardnesses within a range of hardnesses using the same components, comprising the steps of:
a. selecting a first curative component having a low hardness when mixed alone with the hardener,
b. selecting a second curative component having a high hardness when mixed alone with the hardener, c. mixing the first and second components together with a hardener in predetermined proportions to create a polyurethane compound having a predetermined hardness in a range between the low hardness and the high hardness.

15. The method of claim 14 in which the hardener is an isocyanate.

16. The method of claim 15 in which the hardener is methylene diphenyl isocyanate.

17. The method of claim 15 in which the range of hardnesses is between 10 Shore A and 90 Shore A.

18. The method of claim 17 in which the first curative component comprises a composition containing glycol polyol, non reactive plasticizer, urethane catalyst, and a surfactant.

19. The method of claim 18 in which the second curative component comprises a composition containing glycol polyol, liquid aromatic diamine, urethane catalyst, and a surfactant.
